(19) United States
(12) Patent Application Publication
(10) Pub. No.: US 2007/0177073 A1
(43) Pub. Date: Aug. 2, 2007

(54) DISPLAY PANEL, METHOD OF MANUFACTURING THE SAME AND SPACER PRINTING APPARATUS FOR THE SAME

(76) Inventors: Bong-Sung Seo, Yongin-si (KR); So-Youn Park, Suwon-si (KR); Jeong-Uk Heo, Seongnam-si (KR)

Correspondence Address: Frank Chau, Esq.;F. CHAU & ASSOCIATES, LLC, 130 Woodbury Road, Woodbury, NY, 11797, US

(21) Appl. No.: 11/555,858

(22) Filed: Nov. 2, 2006

(30) Foreign Application Priority Data
Feb. 1, 2006 (KR) 2006-9601

(51) Int. Cl. G02F 1/1333

(52) U.S. Cl. 349/110

(57) ABSTRACT

A display panel includes a first substrate a second substrate, a liquid crystal layer, a black matrix and a plurality of dots. The second substrate faces the first substrate. The liquid crystal layer is interposed between the first and second substrates. The black matrix is formed on at least one of the first and second substrates to block light. The dots are interposed between the first and second substrates corresponding to the black matrix. Each of the dots includes a plurality of spacers aligned in a predetermined direction.

### CROSS-REFERENCE TO RELATED APPLICATIONS

The present application claims priority from Korean Patent Application No. 2006-9601, filed on Feb. 1, 2006, the disclosure of which is hereby incorporated herein by reference in its entirety.

### BACKGROUND OF THE INVENTION

1. Technical Field

The present disclosure relates to a display panel, a method of manufacturing the display panel and a spacer printing apparatus for the method of manufacturing the display panel. More particularly, the present disclosure relates to a display panel capable of improving an image display quality, a method of manufacturing the display panel and a spacer printing apparatus for the method of manufacturing the display panel.

2. Description of the Related Art

A liquid crystal display (LCD) device is a type of flat panel display device that displays an image using a liquid crystal layer. The LCD device has various characteristics such as thinner thickness, lighter weight, lower power consumption, lower driving voltage, etc., than other types of display devices.

The LCD device can include an LCD panel and a backlight assembly. The LCD panel displays the image by using light transmittance of the liquid crystal layer. The backlight assembly is disposed under the display panel to supply the LCD panel with light.

The LCD panel can include an array substrate, a color filter substrate, a liquid crystal layer, a seal line and a plurality of spacers. The array substrate can include a plurality of thin film transistors (TFTs) that switches elements The color filter substrate faces the array substrate and can include a plurality of color filters. The LCD panel can include the liquid crystal layer interposed between the array substrate and the color filter substrate. The seal line is interposed between the array substrate and the color filter substrate to seal the liquid crystal layer. The spacers are interposed between the array substrate and the color filter substrate to maintain a cell gap between the array substrate and the color filter substrate.

The color filter substrate in general, further can include a black matrix that surrounds the color filters to block a portion of the light. The spacers correspond to the black matrix.

The liquid crystal layer is formed through an injection method or a dropping method.

In the dropping method, the seal line and the spacers are formed on the color filter substrate. A liquid crystal is dropped on the array substrate. The array substrate is combined with the color filter substrate in a vacuum to complete the LCD panel. The spacers, in general, are coated on the color filter substrate through a printing method using a printing roller.

When the spacers are coated on the color filter substrate through the printing method, a portion of the spacers are formed on the color filters by a misalignment between the color filter substrate and the printing roller. The spacers on the color fitters block a portion of the tight incident into the color filter substrate, to deteriorate image display quality of the LCD panel.

### SUMMARY OF THE INVENTION

Embodiments of the present invention provide a display panel capable of improving an image display quality, a method of manufacturing the above-mentioned display panel and a spacer printing apparatus for the above-mentioned method of manufacturing the display panel.

In an embodiment of the present invention, a display panel includes a first substrate, a second substrate, a liquid crystal layer, a black matrix and a plurality of dots.

The second substrate faces the first substrate. The liquid crystal layer is interposed between the first and second substrates. The black matrix is formed on at least one of the first and second substrates to block light. The dots are interposed between the first and second substrates corresponding to the black matrix. Each of the dots includes a plurality of spacers aligned in a predetermined direction.

In an embodiment of the present invention, a method of manufacturing a display panel is provided as follows. A plurality of spacers is aligned on a back matrix of a first substrate in a predetermined direction using a printing roller. A seat line is formed on the first substrate. A plurality of liquid crystal droplets is dropped on a second substrate. The first substrate is combined with the second substrate.

In an embodiment of the present invention, a spacer printing apparatus includes a printing plate and a printing roller.

The printing plate includes a plurality of receiving recesses. Each of the receiving recesses has a substantially elliptical shape extended in a predetermined direction when viewed on a plane to receive a plurality of spacers. The printing roller is rolled on the printing plate so that the spacers are attached to a surface of the printing roller, and is rolled on a display substrate to print the attached spacers onto the display substrate.

According to an embodiment of the present invention, the spacers are aligned on the black matrix in a predetermined direction, and have a predetermined margin so that the spacers may not be formed on the color filters, even though the printing roller may be misaligned with respect to the display substrate thereby improving image display quality.

### BRIEF DESCRIPTION OF THE DRAWINGS

Exemplary embodiments of the present invention can be understood in more detail from the following descriptions taken in conjunction with the accompanying drawings in which,

FIG, 1 is a perspective view illustrating a display panel in accordance with an exemplary embodiment of the present inventions,

FIG. 2 is a cross-sectional view taken along the line I-I′ shown in FIG. 1,

FIG. 3 is a plan view illustrating a second substrate of the display panel shown in FIG. 1;

FIG. 4 is an enlarged plan view illustrating the portion ‘A’ shown in FIG, 3,

FIG. 5 is a plan view illustrating a plurality of spacers arranged in a substantially circular shape in accordance with an exemplary embodiment of the present invention,

FIG. 6 is a plan view illustrating a second substrate of a display panel in accordance with an exemplary embodiment of the present invention; and

FIGS. 7 to 15 are cross-sectional views illustrating a method of manufacturing a display panel in accordance with an exemplary embodiment of the present invention.

### DESCRIPTION OF THE EXEMPLARY EMBODIMENTS

The invention is described more fully hereinafter with reference to the accompanying drawings, in which embodiments of the invention are shown. This invention may, however, be embodied in many different forms and should not be construed as limited to the embodiments set forth herein.

Hereinafter, an embodiment of the present invention will be described in detail with reference to the accompanying drawings.

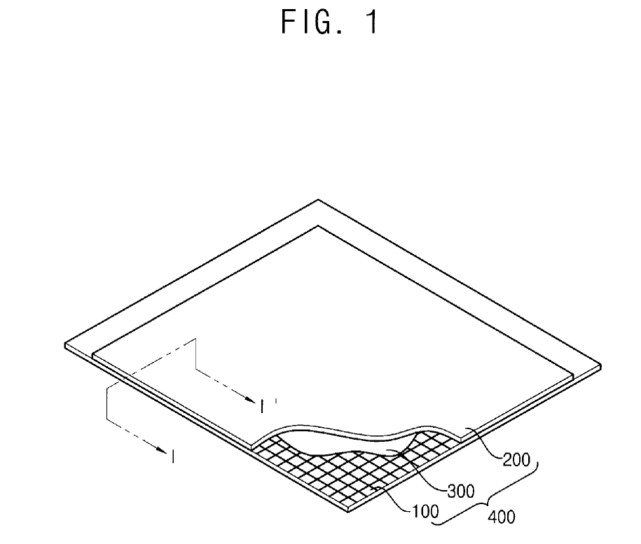

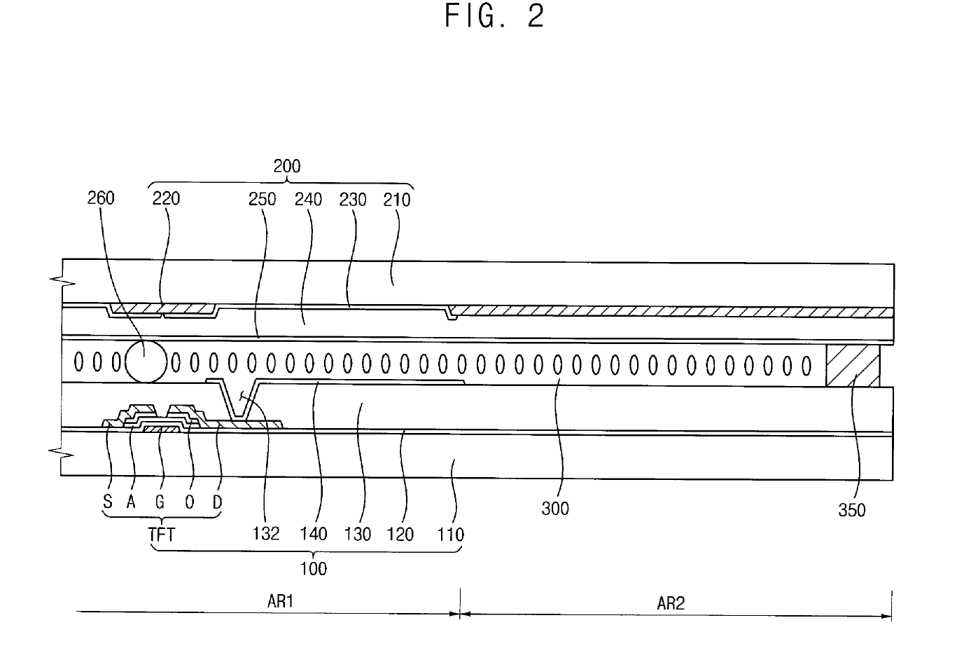

FIG. 1 is a perspective view illustrating a display panel in accordance with an embodiment of the present invention, FIG. 2 is a cross-sectional view taken along the line I-I′ shown in FIG. 1.

Referring to FIGS. 1 and 2, the display panel 400 includes a first substrate 100, a second substrate 200, a liquid crystal layer 300, a spacer 260 and a seal line 350. The display panel 400 displays an image by using light. The display panel 400 is divided into a display region AR1 and a peripheral region AR2 surrounding the display region AR1.

The first substrate 100 includes a first transparent substrate 110, a gate line (not shown), a data line (not shown), a storage line (not shown), a gate insulating layer 120, a thin-film transistor (TFT), a passivation layer 130 and a pixel electrode 140. Alternatively, the first substrate 100 may further include a plurality of gate lines, a plurality of data lines, a plurality of storage lines, a plurality of TFTs and a plurality of pixel electrodes.

The first transparent substrate 110 may have a substantially plate shape, and includes a transparent material. For example, the first transparent substrate 110 may include a glass substrate, a quartz substrate, etc.

The gate lines are formed on the first transparent substrate 110, and are extended in a first direction. The data lines are formed on the first transparent substrate 110, and are extended in a second direction that is substantially perpendicular to the first direction. The storage lines are substantially in parallel with the gate lines.

The gate insulating layer 120 is formed on the first transparent substrate 110 to cover the gate lines and the storage lines. The gate lines are formed under the gate insulating layer 120, and the data lines are formed on the gate insulating layer 120. Thus, the gate lines are electrically insulated from the data lines.

The gate lines cross the data lines, and are substantially perpendicular to the data lines. A plurality of unit pixels is defined by the data and gate lines in the display region AR1 of the first substrate 100. Each of the TFTs and each of the pixel electrodes 140 are formed in each of the unit pixels.

The TFTs are formed in the unit pixels, respectively. Each of the TETs includes a gate electrode G, a source electrode S, a drain electrode D, an active layer A and an ohmic contact layer O.

The gate electrode G is formed on the first transparent substrate 110, and is extended from one of the gate lines in the second direction. The source electrode S is extended from one of the data lines in the first direction, and is partially overlapped with the gate electrode G. The drain electrode D is spaced apart from the source electrode S by a predetermined distance, and is partially overlapped with the gate electrode G. The drain electrode D is electrically connected to each of the pixel electrodes 140 through a contact hole 132 The active layer A is formed between the source and drain electrodes S and D on the gate electrode G, and covers the gate electrode G. The ohmic contact layer O is interposed between the active layer A and the source electrode S, and between the active layer A and the drain electrode D.

The passivation layer 130 is formed on the gate insulating layer 120 to cover the TFTs to protect the TFTs from externally provided heat or moisture. A portion of the passivation layer 130 corresponding to the drain electrode D that is extended toward a central portion of each of the unit pixels is partially removed to form the contact hole 132. Alternatively, a plurality of contact holes may be formed through the passivation layer 130.

The pixel electrodes 140 are formed on the unit pixels, respectively, and are arranged in a matrix shape. The pixel electrodes 140 include a transparent conductive material. Each of the pixel electrodes 140 is electrically connected to the drain electrode D of each of the TETs through the contact hole 132. Each of the pixel electrodes 140 receives a driving voltage from each of the TFTs. Each of the pixel electrodes 140 is partially overlapped with one of the storage lines to maintain a voltage difference between the pixel electrode 140 and a common electrode 250 of the second substrate 200.

The second substrate 200 faces the first substrate 100. The second substrate 200 includes a second transparent substrate 210, a black matrix 220, a color filter 230, an overcoating layer 240 and a common electrode 250.

The second transparent substrate 210 may have a substantially plate shape. The second transparent substrate 210 may include substantially the same transparent material as the first substrate 110.

The black matrix 220 is formed on the second transparent substrate 210 to block light. In particular, the black matrix 220 is formed on the peripheral region AR2 of second transparent substrate 210 and a portion of the display region AR1 of the second transparent substrate 210.

The black matrix 220 is formed on the second transparent substrate 210 corresponding to the gate lines, the data lines, the storage line and the TFTs of the first substrate 100 so that the gate lines, the data lines, the storage line and the TFTs may not be viewed from the exterior of the display panel 400. For example, the black matrix 220 includes an opaque inorganic material such as chromium (Cr).

The color filters 230 correspond to the pixel electrodes 140 that are arranged in a matrix shape, respectively. The color filters 230 are formed on the second transparent substrate 210. For example, the color filters 230 may include a red (R) color filter, a green (G) color filter and a blue (B) color filter.

The overcoating layer 240 is formed on the second transparent substrate 210 to cover the black matrix 220 and the color filters 230, and to planarize a surface of the second substrate 200. For example, the overcoating layer 240 may include a transparent organic material.

The common electrode 250 is formed on the overcoating layer 240, and includes a transparent conductive material. The common electrode 250 may include substantially the same material as the pixel electrodes 140. When a common voltage and the driving voltage are applied to the common electrode 250 and each of the pixel electrodes 140, an electric field is generated between the common electrode 250 and the pixel electrode 140.

The liquid crystal layer 300 is interposed between the first and second substrates 100 and 200, and includes liquid crystal. The liquid crystal of the liquid crystal layer 300 varies in its molecular arrangement in response to the electric field applied thereto. In particular, the electric field generated between each of the pixel electrodes 140 of the first substrate 100 and the common electrode 250 of the second substrate 200. Thus, light transmittance of the liquid crystal layer 300 is changed, and light having passed through the liquid crystal layer 300 passes through each of the color filters 230 to display the image.

The spacers 260 are interposed between the first and second substrates 100 and 200 to maintain a cell gap between the first and second substrates 100 and 200. The spacers 260 correspond to the black matrix 220.

The seal line 350 is interposed between the first and second substrates 100 and 200, and corresponds to the peripheral region AR2 of the second transparent substrate 210. The seal line 350 may have a closed loop shape, For example, the seal line 350 may include a sealant so that the first substrate 100 is combined with the second substrate 200. The seal line 350 may be on an outermost portion of the peripheral region AR2 to seal the liquid crystal layer 300 so that the liquid crystal of the liquid crystal layer 300 does not leak.

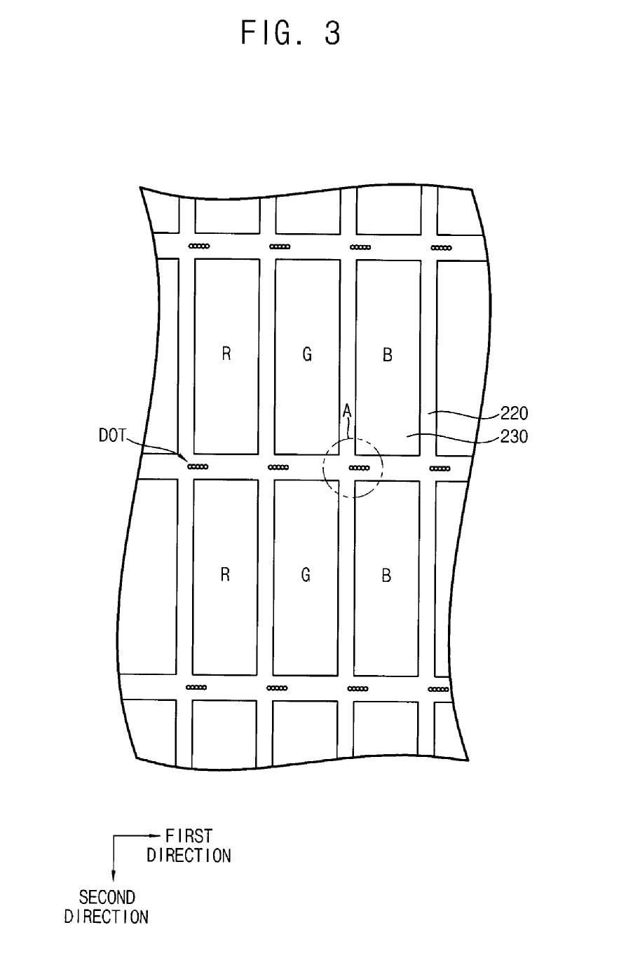

FIG. 3 is a plan view illustrating a second substrate of the display panel shown in FIG. 1.

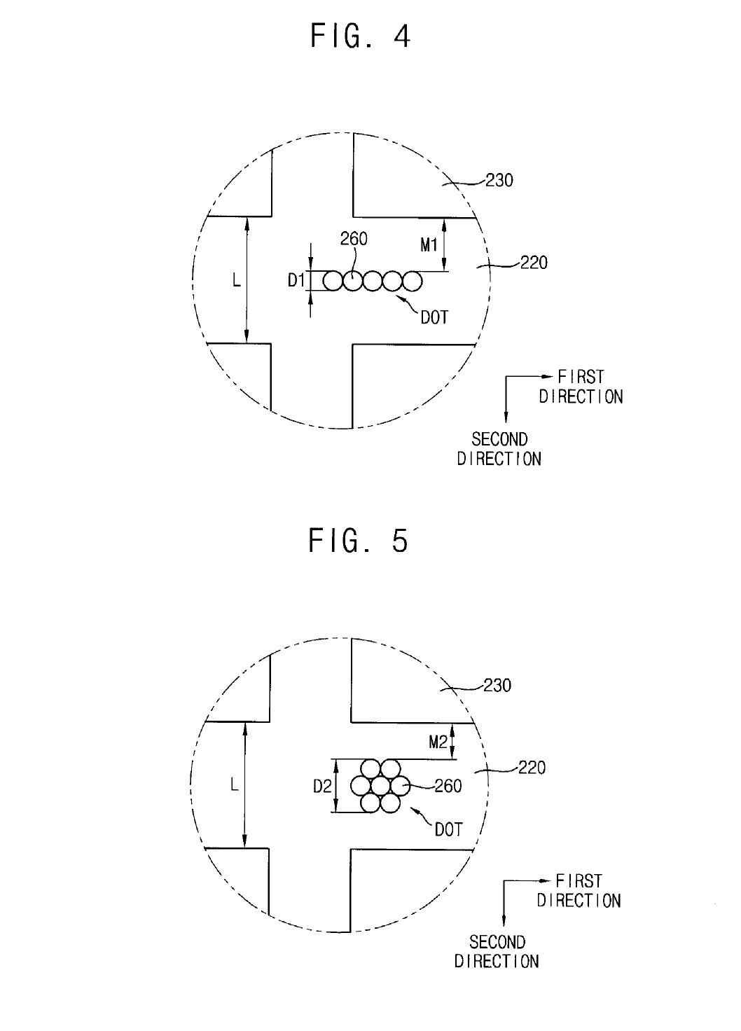

FIG. 4 is an enlarged plan view illustrating the portion ‘A’ shown in FIG. 3.

Referring to FIG. 3, the spacers 260 correspond to the black matrix 220 of the second substrate 200. The spacers 260 are divided into a plurality of groups along a predetermined direction. A portion of the spacers 260 in each of the groups forms a spacer dot DOT. That is, the spacers 260 are divided into a plurality of spacer dots DOT.

The color filters 230 correspond to the pixel electrodes 140 of the first substrate 100. The color filters 230 may be spaced apart from each other, and arranged in the first and second directions. For example, the color filters 230 may include the red (R) color filter, the green (G) color filter and the blue (B) color filter. In particular, the R, G and B color filters are arranged in the first direction, preferably in sequence, and each of the R, G and B color filters is repetitively formed in the second direction.

The black matrix 220 is formed between the color filers 230. That is, the black matrix 220 is formed in a region that is defined by adjacent color filters 230. The black matrix 220 may be extended in the first and second directions to form a net shape.

Each of the spacer dots DOT includes spacers 260 of a predetermined number. The spacers 260 of each of the spacer dots DOT may be aligned in the first direction that is a longitudinal direction of the black matrix 220. For example, the number of the spacer dots DOT may be substantially the same as that of the color filters 230. The spacer dots DOT may be spaced apart from each other, and arranged in the first and second directions.

For example, the number of the spacers 260 of each of the spacer dots DOT is about five to about eight, and the spacers 260 of each of the spacer dots DOT are arranged in the first direction.

Referring to FIG. 4, the spacer dots DOT are arranged along a center of a width L of the black matrix 220 in the first direction. Each of the spacer dots DOT is spaced apart from a side of the black matrix 220 by a predetermined margin M1. That is, each of the spacer dots DOT is spaced apart from each of the color filters 230 by the margin M1.

Each of the spacers 260 has a substantially spherical shape. The width L of the black matrix 220 is substantially the same as a summation of a diameter D1 of each of the spacers 260 and twice the margin M1. For example, the diameter D1 of each of the spacers 260 is about 3 μm to about 5 μm, the width L of the black matrix 220 is about 25 μm to about 35 μm, and the margin M1 of each of the spacer dots DOT is about 10 μm to about 16 μm.

FIG. 5 is a plan view illustrating a plurality of spacers arranged in a substantially circular shape in accordance with an exemplary embodiment of the present invention. The spacer dots of FIG. 5 will be compared with the spacer dots shown in FIG. 4.

Referring to FIG, 5, the spacer dot DOT includes a plurality of spacers 260 arranged in a substantially circular shape. The number of the spacers 260 in each of the spacer dot DOT is about five to eight. The spacer dot DOT is on a central line of a black matrix 220.

The spacer dot DOT is spaced apart from a side of the black matrix 220 by a margin M2. That is, the spacer dot DOT is spaced apart from each of the color filters 230 by the margin M2. A width L of the black matrix 220 is substantially the same as a summation of a width D2 of the spacer dot DOT and twice the margin M2. For example, the width D2 of the spacer dot DOT is about 12 μm to about 15 μm, and the margin M2 of the spacer dot DOT is about 5 μm to about 12 μm.

Referring again to FIGS. 4 and 5, the margin M1 of the spacer dot DOT of FIG. 4 is greater than the margin M2 of the spacer dot DOT shown in FIG. 5. In particular, the margin M1 of the spacer dot DOT shown in FIG. 5 is about 10 μm to about 16 μm, and the margin M2 of the spacer dot DOT of FIG. 4 is about 5 μm to about 12 μm. Therefore: the margin M1 of the spacer dot DOT of FIG. 4 is greater than the margin M2 of the spacer dot DOT shown in FIG. 5 by about 4 μm to about 5 μm.

The spacers 260, in general, are formed on the black matrix 220 of the second substrate 200 using a printing roller (not shown). Even though the printing roller may be misaligned with respect to the second substrate 200 in the second direction, the spacers 260 may be printed on the color filters 230 to block a portion of the light passing through the color filters 230.

However, when the spacers 260 are aligned along the central line of the black matrix 220, the margin M1 is increased. Therefore, even though the printing roller may be misaligned with respect to the second substrate 200 in the second direction, the spacers 260 may be printed on the black matrix 220.

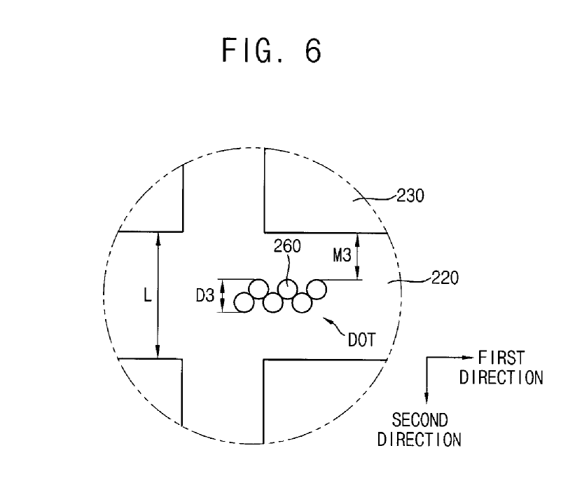

FIG. 6 is a plan view illustrating a second substrate of a display panel in accordance with an exemplary embodiment of the present invention. The display panel of FIG. 6 is substantially the same as in FIGS. 1 to 5 except for spacers. Thus, the same reference numerals will be used to refer to the same or like parts as those described in FIGS. 1 to 5.

Referring to FIG. 6, each of a plurality of spacer dots DOT includes a plurality of spacers 260 arranged in a zigzag pattern aligned in a longitudinal direction of a black matrix 220. The longitudinal direction of the black matrix 220 may be a first direction. Alternatively, the longitudinal direction of the black matrix 220 may be a second direction that is substantially perpendicular to the first direction. The number of the spacer dots DOT is substantially the same as that of color filters 230, and the spacer dots DOT are spaced apart from each other in the first direction and the second direction.

For example, the number of the spacers 260 of each of the spacer dots DOT is about five to about eight. The spacers 260 of each of the spacer dots DOT are arranged in the zigzag pattern in the first direction, and a width DS of each of the spacer dots DOT is about 5 μm to about 6 μm.

The spacer dots DOT are on a central line of the black matrix 220. Each of the spacer dots DOT is spaced apart from a side of the black matrix 220 by a margin M3. That is, each of the spacer dots DOT is spaced apart from each of the color filters 230 by the margin M3. A width L of the black matrix 220 is substantially the same as a summation of the width DS of the spacer dot DOT and twice the margin M3. For example, when the width L of the black matrix 220 is about 25 μm to about 35 μm, the margin M3 of the spacer dot DOT is about 10 μm to about 15 μm.

Therefore, the spacers 260 of each of the spacer dots DOT are aligned in the zigzag pattern at the central line of the black matrix 220. And the spacers 260 may be printed on the black matrix 220, even though a printing roller (not shown) may be misaligned in the second direction with respect to a second substrate 200.

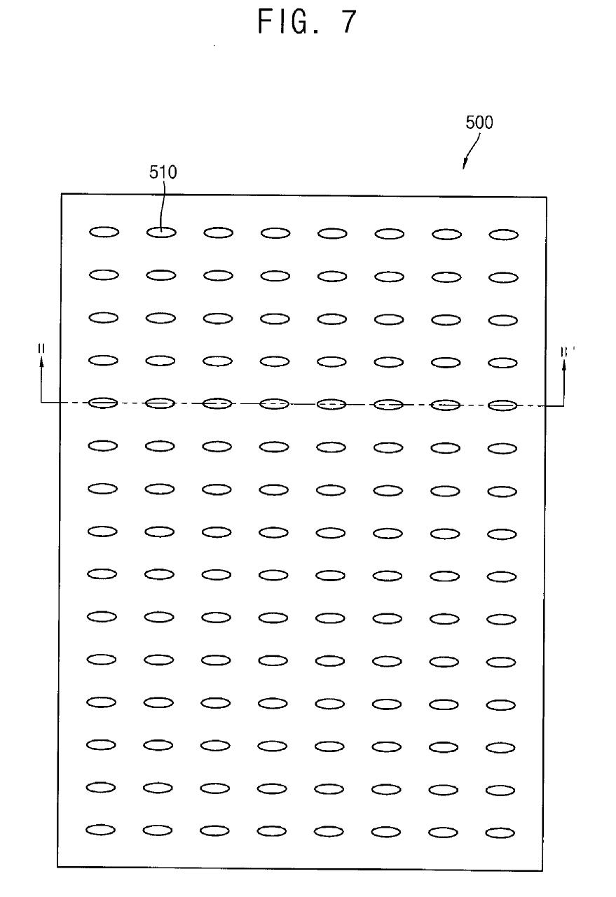

FIGS. 7 to 15 are cross-sectional views illustrating a method of manufacturing a display panel in accordance with an exemplary embodiment of the present invention.

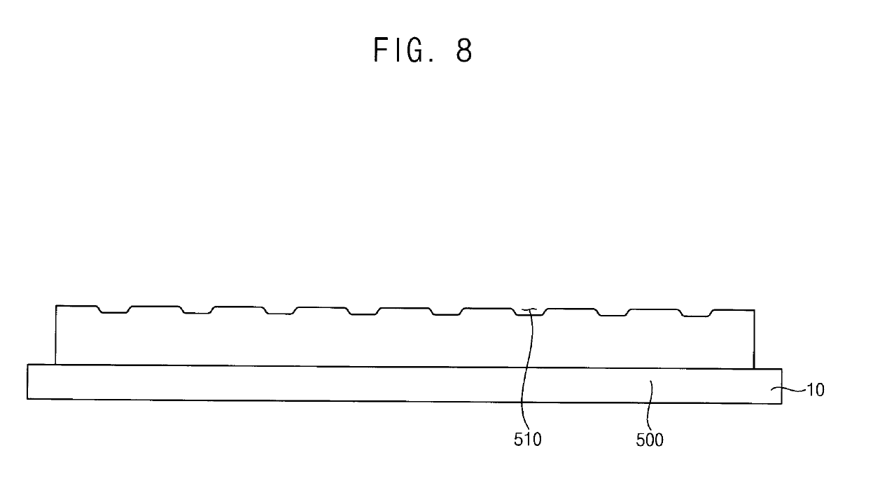

FIG. 7 is a plan view illustrating a printing plate including a plurality of receiving recesses in accordance with an exemplary embodiment of the present invention. FIG. 8 is a cross-sectional view taken along the line II-II′ shown in FIG. 7.

Referring to FIGS. 7 and 8, the printing plate 500 including the receiving recesses 510 is disposed on a stage 10. The receiving recesses 510 are spaced apart from each other by a constant distance. For example, the receiving recesses 510 are arranged in a matrix shape when viewed on a plane.

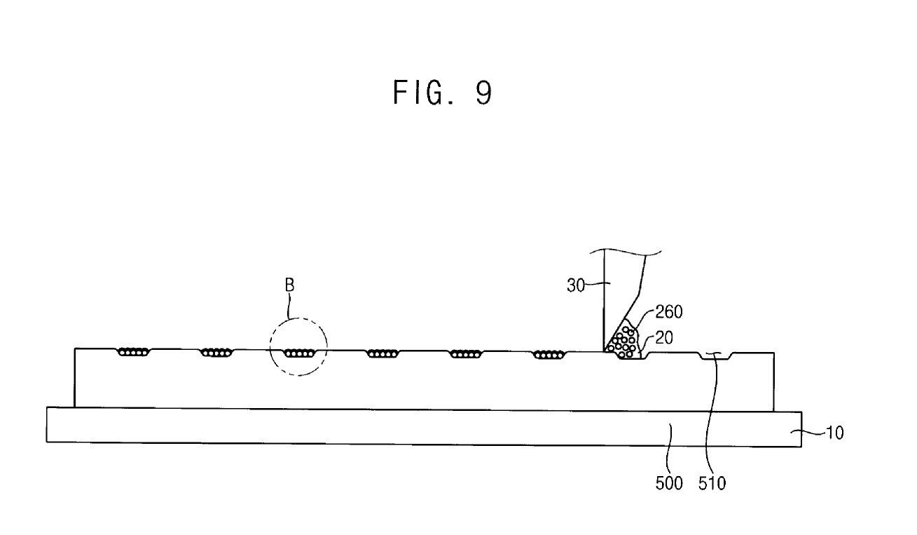

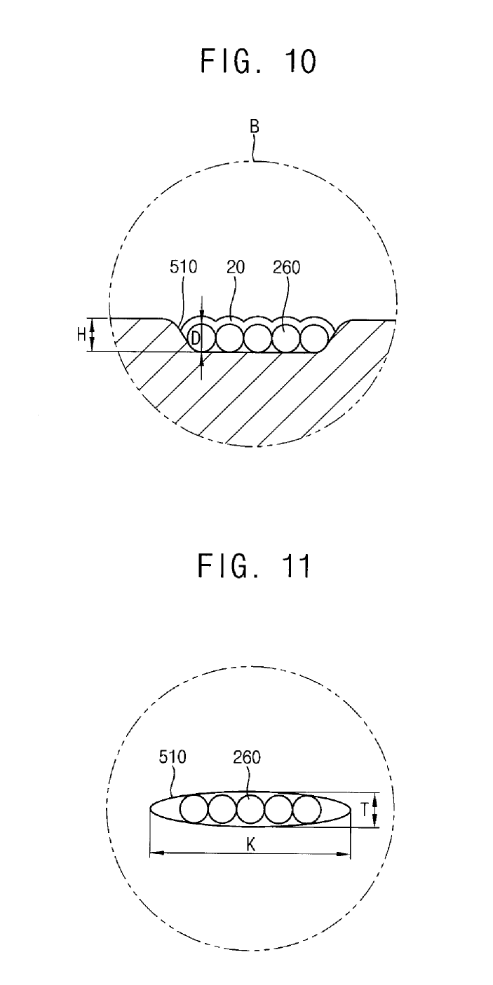

FIG. 9 is a cross-sectional view illustrating filling the receiving recesses with spacers in accordance with an embodiment of the present invention. FIG. 10 is an enlarged cross-sectional view illustrating the portion ‘B’ shown in FIG. 9. FIG. 11 is a plan view illustrating the spacers filled in the receiving recesses shown in FIG. 9.

Referring to FIG. 9, the spacers 260 are filled in the receiving recesses 51 0 of the printing plate 500.

For example, to fill the receiving recesses 510 with the spacers 260, the spacers 260 are ejected onto the printing plate 500 through a spacer nozzle (not shown). The spacers 260 may be mixed with an ink 20, and the mixture is ejected onto the printing plate 500 through the spacer nozzle. The ink 20 has a 20 predetermined viscosity, and may be solidified by heat. For example, the ink 20 includes a white ink. Alternatively, the ink 20 may include a melamine resin, a polyester resin: etc.

After the spacers 260 are ejected onto a surface of the printing plate 500, a blade 30 is moved along the surface of the printing plate 500 from one side of the printing plate 500 to an opposite side of the printing plate 500 so that the spacers 260 are uniformly filled in the receiving recesses 510. In addition, a remaining portion of the spacers 260 that are not received in the receiving recesses 510 is removed from the surface of the printing plate 500.

Referring to FIGS. 10 and 11, a shape of the printing plate 500 is 5 described in detail.

The receiving recesses 510 having a substantially elliptical shape that is extended in a predetermined direction are formed on the surface of the printing plate 500 to receive the spacers 260. The receiving recesses 510 are arranged in a matrix shape. Each of the spacers 260 may have a substantially spherical shape. A diameter D of each of the spacers 260 may be about 3 μm to about 5 μm.

A depth H of each of the receiving recesses 510 may be greater than the diameter D of each of the spacers 260 by about 0.1 μm to about 0.2 μm. In particular, the depth H of each of the receiving recesses 510 may be about 3.1 μm to about 5.2 μm.

A width T of each of the receiving recesses 510 may be greater than the diameter D of each of the spacers 260 by about 1 μm to about 3 μm. In particular, the width T of each of the receiving recesses 510 may be about 4 μm to about 8 μm. A length K of each of the recesses 510 may be about 20 μm to about 30 μm.

For example, the number of the spacers 260 received in each of the receiving recesses 510 is about five to about eight. The spacers 260 in each of the receiving recesses 510 may be aligned in a substantially linear pattern or a zigzag pattern.

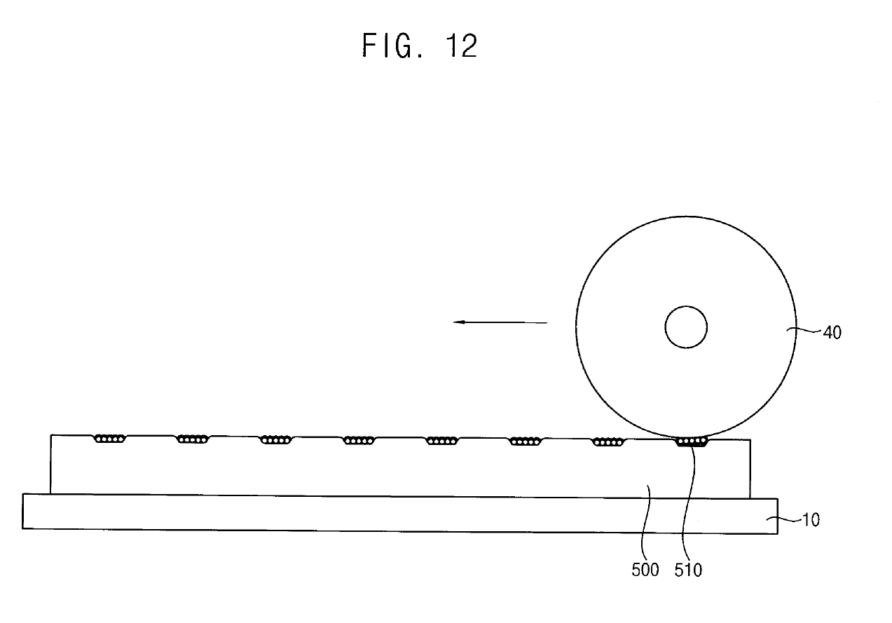

FIG. 12 is a cross-sectional view illustrating attaching of the spacers to a printing roller in accordance with an exemplary embodiment of the present invention.

Referring to FIG. 12, the printing roller 40 is rolled on the surface of the 5 printing plate 500 so that the spacers 260 are attached to a surface of the printing roller 40. That is, the printing roller 40 makes contact with the surface of the printing plate 500, and is rolled on the surface of the printing plate 500 so that the spacers 260 that are filled in the receiving recesses 510 are attached to the surface of the printing roller 40. In particular, the ink 20 having the viscosity is coated on the spacers 260 so that the spacers 260 may be easily attached to the surface of the printing roller 40. In FIG. 12, an adhesive strength between the ink 20 and the printing plate 500 is smaller than an adhesive strength between the ink 20 and the printing roller 40.

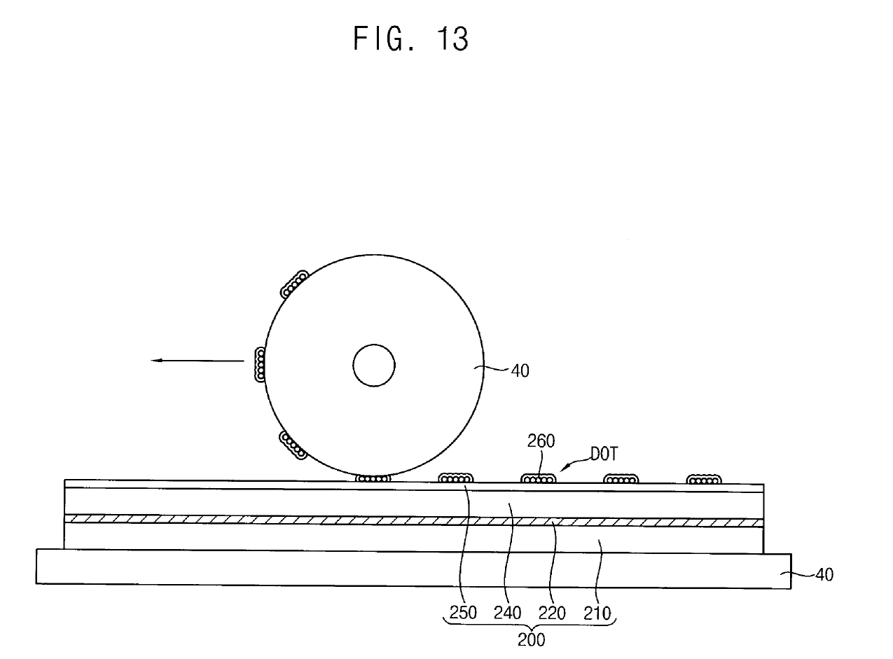

FIG. 13 is a cross-sectional view illustrating printing the spacers on a second substrate in accordance with an exemplary embodiment of the present invention.

Referring to FIG. 13, the printing roller 40 is rolled on the second substrate 200 so that the spacers 260 attached to the surface of the printing roller 40 are printed on the second substrate 200. That is, the printing roller 40 makes contact with the second substrate 200, and is rolled on the second substrate 200 so that the spacers 260 attached to the surface of the printing roller 40 is printed on the second substrate 200. The ink 20 having the viscosity is coated on the spacers 260 so that the spacers 260 may be easily printed to the second substrate 200. In FIG. 13, the adhesive strength between the ink 20 and the printing roller 40 is smaller than an adhesive strength between the ink 20 and the second substrate 200.

The second substrate 200, to which the spacers 260 are attached, may include a color filter substrate. The color filter substrate includes a second transparent substrate 210, a black matrix 220, a plurality of color filters 230, an overcoating layer 240 and a common electrode 250. The spacers 260 correspond to the black matrix 220.

Particularly, the spacers 260 correspond to the black matrix 220 of the second substrate 200, and are divided into a plurality of groups. The spacers 260 of each of the groups are referred to as a spacer dot DOT. That is, the spacers 260 are divided into the groups to form a plurality of spacer dots DOT. The spacer dots DOT are aligned in a longitudinal direction of the black matrix 220. The spacers 260 of each of the spacer dots DOT may be arranged in a substantially linear pattern or a zigzag pattern aligned in the longitudinal direction of the black matrix 220. For example, the spacers 260 of each of the spacer dots DOT may be on a central line of the black matrix 220.

A printing direction of the printing roller 40 may be substantially in parallel with an aligning direction of the spacers 260. That is, the printing direction of the printing roller 40 is substantially in parallel with the longitudinal direction of each of the spacer dots DOT.

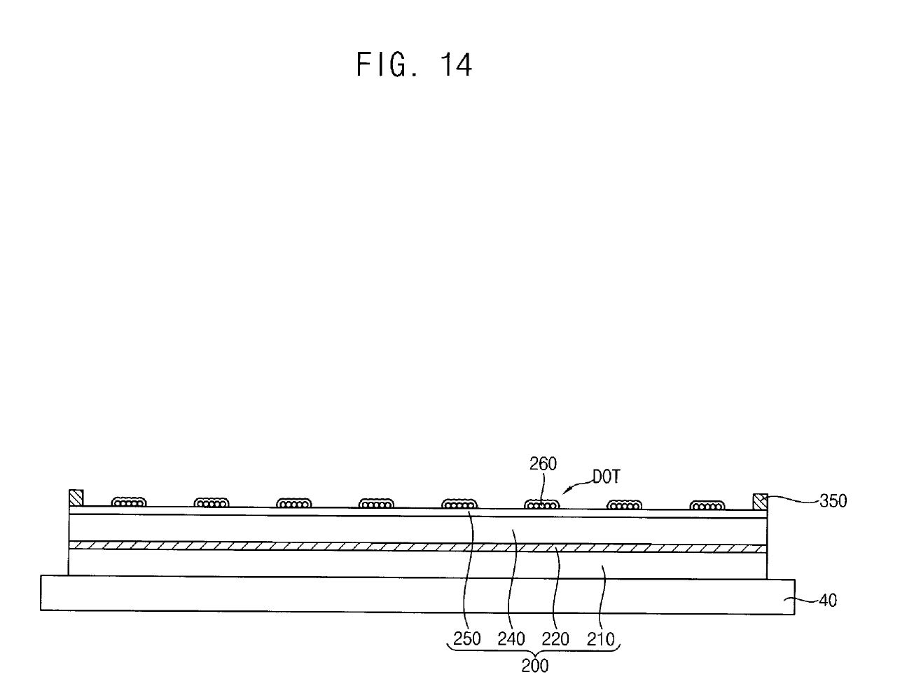

FIG. 14 is a cross-sectional view illustrating forming a seal line on the second substrate shown in FIG. 13.

Referring to FIG. 14, after the spacers 260 are printed on the second substrate 200, the seal line 350 is formed on the second substrate 200.

The second substrate 200 includes a display region and a peripheral region. An image is displayed on the display region. The peripheral region surrounds the display region. The seal line 350 is formed in the peripheral region of the second substrate 200. The seal line 350 may have a closed loop shape. For example, the seal line 350 includes a sealant and a seal spacer (not shown). The sealant is solidified by heat. The seal spacer is disposed in the sealant, and maintains the cell gap between the first substrate 100 and the second substrate 200.

A plurality of liquid crystal droplets is dropped on the first substrate 100. Each of the liquid crystal droplets includes a plurality of liquid crystal molecules. For example, the first substrate 100 includes an array substrate. The array substrate includes a first transparent substrate 11I, a gate insulating layer 120, a plurality of TFTs, a passivation layer 130 and a plurality of pixel electrodes 140.

In FIGS. 7 to 14, the spacers 260 and the seal line 350 are formed on the second substrate 200 that is the color filter substrate, and the liquid crystal droplets are dropped on the first substrate 100. Alternatively, the spacers 260 and the seal line 350 may be formed on the first substrate 100, and the liquid crystal droplets may be formed on the second substrate 200.

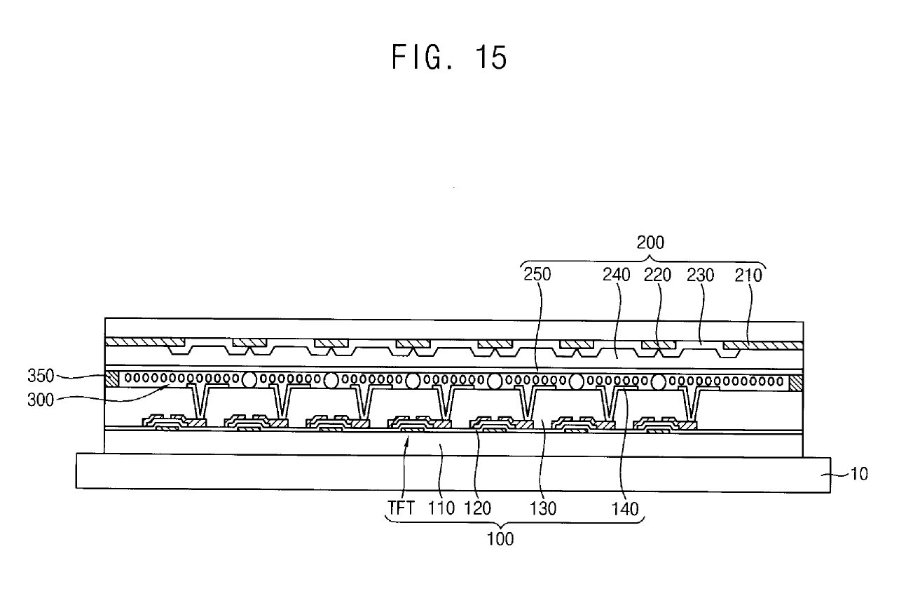

FIG. 15 is a cross-sectional view illustrating combining the first substrate with the second substrate shown in FIG. 14 to form a display panel. In particular, in FIG. 15, a cross-section of the display panel taken along a longitudinal direction of the spacer dot is illustrated.

Referring to FIG. 15, the first substrate 100 is combined with the second substrate 200 to form the display panel. The liquid crystal droplets dropped on the first substrate 100 is spread between the first and second substrates 100 and 200. The first substrate 100 is combined with the second substrate 200 through the seal line 350, and the first and second substrates 100 and 200 are sealed to prevent leakage of the liquid crystal in the liquid crystal layer 300.

The seal tine 350 is heated to be solidified to securely combine the first substrate 100 with the second substrate 200. When the seal tine 350 is solidified, the ink 20 coated on the spacers 260 is also solidified. Thus, the spacers 260 are securely fixed between the first and second substrates 100 and 200.

According to the method of FIGS. 7 to 15, the printing roller 40 prints the spacers 260 on the second substrate 200 along the central line of the black matrix 220 in the substantially linear pattern or the zigzag pattern. Thus, the spacers 260 may not be formed on the color filters 230, even though the printing roller 40 may be misaligned with respect to the second substrate 200 in the second direction.

According to at least one embodiment of the present invention, the spacers are aligned in the central line of the black matrix as the substantially linear pattern or the zigzag pattern, thereby increasing the manufacturing margin of the display substrate. Thus, the spacers may not be formed on the color filters, even though the printing roller may be misaligned with respect to the display substrate, thereby improving image display quality.

Although the illustrative embodiments have been described herein with reference to the accompanying drawings it is to be understood that the present invention is not limited to those precise embodiments, and that various other changes and modifications may be affected therein by one of ordinary skill in the related art without departing from the scope or spirit of the invention. All such changes and modifications are intended to be included within the scope of the invention as defined by the appended claims.

What is claimed is:

1. A display panel comprising:
a first substrate;
a second substrate facing the first substrate;
a liquid crystal layer interposed between the first and second substrates;
a black matrix formed on at least one of the first and second substrates; and
a plurality of dots interposed between the first and second substrates corresponding to the black matrix, each of the dots including a plurality of spacers aligned in a predetermined direction.

2. The display panel of claim 1 wherein the first substrate comprises a plurality of pixel electrodes and a plurality of thin-film transistors (TFTS) that drive the pixel electrodes., respectively,
wherein the second substrate includes a plurality of color filters arranged to substantially correspond to the arrangement of the pixel electrodes and the black matrix is interposed between the color filters.

3. The display panel of claim 2, wherein the spacers are aligned in a longitudinal direction of the black matrix.

4. The display panel of claim 3, wherein the spacers are on the center of a width of the black matrix.

5. The display panel of claim 3, wherein the spacers are aligned in the longitudinal direction as a substantially linear pattern.

6. The display panel of claim 3, wherein the spacers are aligned in the longitudinal direction in a substantially zigzag pattern.

7. The display panel of claim 3, wherein the number of the spacers aligned in the longitudinal direction is about five to about eight.

8. The display panel of claim 3, wherein a width of the black matrix is about 25 μm to about 35 μm.

9. The display panel of claim 3, wherein a diameter of each of the spacers is about 3 μm to about 5 μm, and each of the spacers has a substantially spherical shape.

10. A method of manufacturing a display panel, comprising:
aligning a plurality of spacers on a black matrix of a first substrate in a predetermined direction using a printing roller;
forming a seal line on the first substrate;
dropping a plurality of liquid crystal droplets onto a second substrate; and
combining the first substrate with the second substrate.

11. The method of claim 10, wherein a printing direction of the printing roller is substantially in parallel with the direction in which the spacers are aligned.

12. The method of claim 10, wherein aligning a plurality of spacers comprises:
filling the spacers in a receiving recess of a printing plate;
rolling the printing roller on the printing plate so that the spacers received in the receiving recess are attached to the printing roller; and
rolling the printing roller on the black matrix of the first substrate to print the spacers onto the first substrate.

13. The method of claim 12, prior to filling the spacers, further comprising coating an ink including a thermosetting resin on the spacers.

14. The method of claim 12, wherein the receiving recess is formed on a surface of the printing plate to receive the spacers, and has a substantially elliptical shape.

15. The method of claim 14, wherein the printing plate further comprises a plurality of receiving recesses arranged in a matrix.

16. The method of claim 14, wherein a depth of the receiving recess is greater than the diameter of each of the spacers by about 0.1 μm to about 0.2 μm.

17. The method of claim 14, wherein a width of the receiving recess is greater than the diameter of each of the spacers by about 1 μm to about 3 μm.

18. The method of claim 14, wherein a length of the receiving recess is about 20 μm to about 30 μm.

19. The method of claim 14, wherein the number of the spacers received in the receiving recess is about five to about eight.

20. A spacer printing apparatus comprising:
a printing plate including a plurality of receiving recesses to receive a plurality of spacers; and
a printing roller rolled on the printing plate so that the spacers are attached to a surface of the printing roller, and rolled on a display substrate to print the attached spacers onto the display substrate.

21. The apparatus according to claim 20, wherein each of the receiving recesses has a substantially elliptical shape.
